(19) United States
(12) Patent Application Publication
(10) Pub. No.: US 2003/0023732 A1
(43) Pub. Date: Jan. 30, 2003

(54) Network based centralized control and management system

(76) Inventor: Michael S. Cohen, Middleton, ID (US)

Correspondence Address: HEWLETT-PACKARD COMPANY, Intellectual Property Administration, P.O. Box 272400, Fort Collins, CO, 80527-2400, US

(21) Appl. No.: 09/805,396

(22) Filed: Mar. 13, 2001

(51) Int. Cl. G06F 15/16; G06F 15/173

(52) U.S. Cl. 709/229; 709/223

(57) ABSTRACT

A method and associated apparatus to secure access to peripheral devices and maintain accounting of usage and billing to users of peripheral devices and documents that are processed by the documents by way of a centralized device. The central device and peripheral devices are connected by a network such as the Internet. The central device performs pattern recognition of documents and maintains user account information, denying or allowing access of users to peripheral devices depending on the user status. Peripheral devices are updated by the central device according to recent account updates and changes.

### BACKGROUND OF THE INVENTION

1. Field of the Invention

This invention relates to a network system, in particular a network system with a centralized device that manages the interface of peripheral devices to users, allowing activities such as billing, security, content provisioning, and access to be maintained by the centralized device.

2. Description of the Related Art

In network based systems, particularly systems using the Internet as a network, users can have access to various document handling devices. These devices can include copiers, scanners, printers, digital senders, and multi functional peripheral (MFP) devices. Users establish access to the devices by establishing a connection on the network, in particular a connection to the Internet. With the exception of a server (servers) that connects the user to the device, a user and device transfer data directly to one another.

The Internet in particular is evolving into a marketplace in which services are continually being made available to users. Users are able to access web-sites providing information and services. Users can also access peripherals by way of the Internet. As computers (users) have been linked to peripherals by way of wide area or local area networks, now the Internet links users with peripherals.

In the future, as peripherals begin to integrate more intelligence and connect to the Internet, technologies will allow new developments in many areas, areas from service and support to communication. Value will be derived from the peripheral and also from services that can be built on top. With the appropriate foundation inside the peripheral, the peripheral can evolve rapidly by adding new capabilities without the requirement of physically upgrading hardware.

At various times and locations, users desire the ability to access, download, transfer, and or print information, particularly protected documents. A user with a mobile wireless computing device having Internet access, can connect to a universal resource locator (URL) of certain documents or data. The user may then desire to access and print the documents or data. The documents or data can be copyrighted. A level of accounting is therefore needed to determine how many copies of the copyrighted document is printed, assess a license fee for the copying and or downloading, and to bill a user. The printer that the user to print from must also account for the users that print from it.

In document management contexts it is often desirable to limit the actions of users or to account for the usage of certain documents (content) or device resources such as printers. In certain cases a particular user or users have limited access to particular documents or data. For copyrighted material with license fee issues, it is desirable to keep track of the number of copies a user downloads, scans, or has copied. These issues deal squarely with the ability of these devices to secure against or bill to users the documents that they are scanning, printing, and or copying. The same issues exist in accounting for usage on output devices such as printers.

It is difficult to build into each local device a sufficiently robust and flexible set of security and billing functions. The device would require continuous updates with security data as to which clients are allowed access. The device would have to be able to maintain accounting data regarding usage by all users. With processors in the individual devices having limited functions, the computing capabilities of devices are limited in their ability to handle security, accounting, and other desirable features when dealing with users accessing remote services offered by these devices.

A need is felt for a method and apparatus that allows users to access remote devices, such as document handling devices. The method and apparatus should be able to efficiently bill users; secure access of users; and update functionality of the devices.

### SUMMARY OF THE INVENTION

What is needed and is disclosed herein is a method and a system that provides a centralized device or facility that handles accounting and security for users and devices that access and provide document and data processing. The method and system reside on a network, and in some embodiments the network is the Internet.

The central device or facility recognizes users and provides access or denial to devices. The central device further maintains accounting and billing data for the users and devices in which documents and data reside, and devices in which documents and data are processed from. In some embodiments, the central device can be logic placed in a remote server. In one embodiment, the remote server is accessed through a network such as the Internet.

In some embodiments, a mark is placed on the document by the handling or processing devices. The central device reads the mark, the central device determines the access or denial to users based on the mark. The mark provides for accounting of access, and processing of the document by users and devices.

In some embodiments, the use of multi-functional peripherals (MFP) are dictated by a the central device through a standard interface such as an embedded virtual machine (EVM) interface.

Other variations of the embodiments are also described.

### BRIEF DESCRIPTION OF THE DRAWINGS

The present invention may be better understood, and it's numerous objects, features and advantages made apparent to those skilled in the art by referencing the accompanying drawings. The use of the same reference number throughout the figures designates a like or similar element.

FIG. 1 illustrates a network architecture of a system using a centralized device or facility.

FIG. 2 illustrates a block diagram of a device connected within the network system

FIG. 3 illustrates a block diagram of a central device or facility.

FIG. 4 illustrates an embodiment of a network architecture where the central device uses application program logic for security and billing policy which runs on a server.

While the invention is susceptible to various modifications and alternative forms, specific embodiments thereof are shown by way of example in the drawings and will herein be described in detail, it should be understood, however, that the drawings and detailed description thereto are not intended to limit the invention to the particular form disclosed but on the contrary, the intention is to cover all modifications, equivalents, and alternatives falling within the spirit and scope of the present invention as defined by the appended claims.

### DETAILED DESCRIPTION

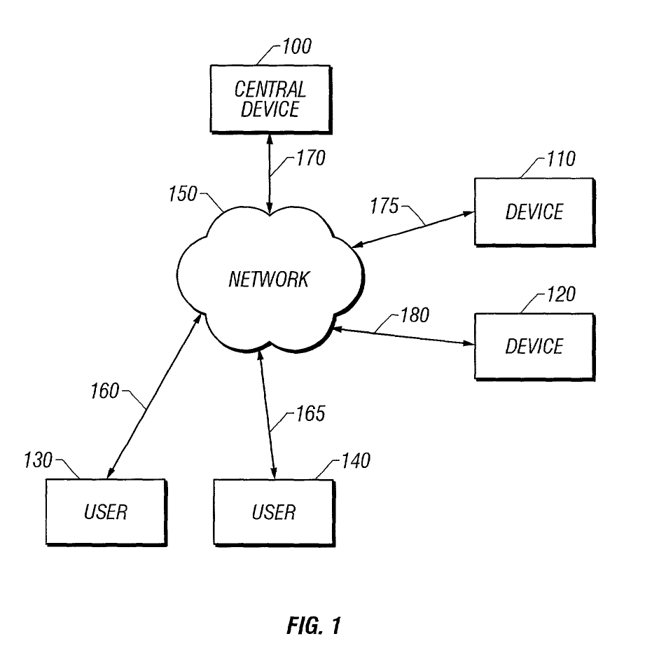

Now referring to FIG. 1, illustrated is a network architecture of a system using a centralized device or facility. A central device 100 is connected by an interface bus or line 170 to a communication network 150.

The communication network 150 can be implemented with a variety of communication mechanisms including mechanisms suitable for a home-based network that include power line communication links, twisted pair communication links, radio frequency communication links, and infrared communications links. The communication network 150 can also be implemented with a variety of larger communication mechanisms, including local area networks connected together by various types of communication links. Further, wireless technologies can be used, technologies that include wireless wide area networks (WWAN), wireless local area networks (WLAN) and wireless personal area networks (WPAN). The communication network 150 may include connection to the world wide web (WWW) of the Internet. The communication network may include one or more communication bridges between the WWW and local area networks and home-based networks. The communications network 150 provides for information protocols, including addresses, to be assigned and identified with users, devices, and central devices. In particular, Internet and WWW information protocols will be provided.

The communication network 150 interfaces to a number of users including user 130 and user 140. Numerous devices, such as device 110 and device 120 are also connected to the network 150 User 130 is connected to the communication network 150 via interface bus 160. User 140 is connected to the communication network 150 via interface bus 165. Device 110 is connected to the communication network 150 via interface bus 175. Device 120 is connected to the communication network 150 via interface bus 180. Depending on the transaction that is to be conducted, a user can directly access a device, or the user can be made to contact the central device 100 prior to interface the device. The central device 100 provides instructions to the device 110 and 120 as to whether to accept a connection to user 130 or user 140. The central device 100 may be a computer server or servers, and may be physically and logically located in one or more locations.

Users, such as user 130 and user 140 are required to have information that identifies to the central device 100 and devices such as device 110 and device 120, information that includes the following: user identity, account codes, permission status, class of service the user is allowed, and the ability for a user to subscribe and be validated.

A device, such as device 110 and device 120, can be a printer that performs image rendering functions. Multi function peripheral (MFP) devices capable of copying, scanning, printing and other functions may also be used as devices in the system. The specific functionality of the devices may be dictated by the central device 100.

When an MFP device such as device 110 and device 120 scans a pattern, this pattern is detected as an illegal or acceptable mark by the MFP device. The central device 100 provides the necessary content to the MFP device to determine the acceptability of the mark or pattern.

The central device 100 is capable of handling multiple patterns and marks, and allows MFP devices to be free to perform device specific functions such as copying, printing, and scanning. The central device 100 with a greater computing capability is able to recognized and read diverse and complicated patterns and marks, patterns and marks that a device such as device 110 and device 120 would not be able to recognize.

The central device 100 can also be updated and made aware of threats or issues, such as revised billing and access information for users. Instead of having individual devices address these updates and changes, the central device 100 handles these threats or issues.

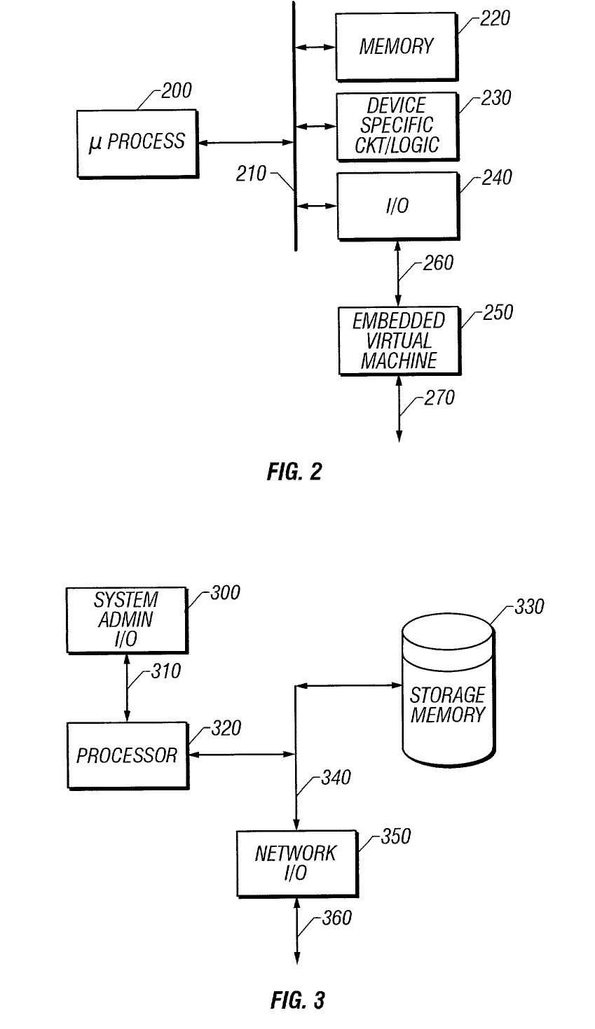

Now referring to FIG. 2, illustrated is a block diagram of a device connected within the system. A device includes a microprocessor 200 that interfaces directly to other logical functions such as a memory 220, device specific circuitry and logic 230, and an input/output (I/O) interface 240. Direct communication of the microprocessor 200 can be on a common bus 210. Variations of devices many include co-processors and other physical or logical components. A variation of the device can also include an embedded virtual machine (EVM) 250 that is connected to the I/O interface 240. In other embodiments the EVM 250 can be integrated into another logical block and can be directly accessed by the micro-processor 200. The EVM 250 interfaces to the communication network 150 by an interface 270.

The EVM 250 receives from and sends to the central device 100 updated information from the central device 100. The EVM 250 implements revised policies as instructed by the central device 100, by hosting downloadable functions that permit or deny access to users, account for user resource usage, report user usage, alert the central device 100, and add or delete security marks on documents. Further, in MFP type devices that are capable of performing various functions, the EVM can be programmed by the central device 100 to provide specific functions.

The EVM 250 acts as a “container” for downloaded applications, such as applets, which extend the functionality of a device running local embedded firmware. The EVM 250 is essentially an operating system (OS) that runs like an application inside another operating system. For peripherals such as printers, firmware exists that runs like an OS. Applications that run on a specific OS can only run on that OS. Likewise, firmware applications unique to particular firmware can only run on that firmware. Therefore the EVM 250 can only run on OS or firmware that the EVM 250 is designed for.

Peripheral firmware can only run compatible applications. The firmware is limited in that it does not provide a framework for any application, but is built to support a few specific functions, all of them known in advance. The EVM 250 is developed specifically to run within the designated firmware or OS. The EVM 250 provides a framework to run applications. Applications are developed to run specifically in the EVM 250, however, it does not matter where the EVM 250 resides. For example, the EVM 250 can reside on various OS or firmware and still be able to run applications. Unlike peripheral firmware, the EVM 250 is flexible and has the ability to deal with numerous applications. The EVM 250 does not need to know in advance what the application will be.

Applications can be developed knowing that they will run on the EVM 250. If custom development environment is required, the only details that need be known are in regards to the EVM 250 and not the underlying OS or firmware. Peripheral firmware can be released, and applications to the EVM 250 can be released later. At a future date capabilities can be added that have not been determined at the time of the release of the peripheral. An application can be sent to run on the EVM 250 in a peripheral and the application can be deleted when it is done. The applications need not be permanently stored on the peripheral. The EVM 250 particularly is well suited for communication over a network or the Internet.

The described EVM 250 architecture is one possible embodiment for modifying the behavior of a device, with the advantage of a well defined environment that allows developers to focus on the value-added features rather than implementation details.

Now referring back to FIG. 1, typically documents that may be manipulated are in an electronic or hard copy (paper) form. Control or security marks can be placed on these documents. The marks can be in a form that is visible or invisible to the user, however, any mark that is used on a document will always be recognized by the central device 100. Devices such as device 110 and 120 that are provided updated information by the central device 100 will be able to read the mark or marks. Marks are used as part of document security or user billing (accounting).

Documents can contain explicit identification marks or be classified by content analysis. Either or both identification schemes are used as a basis for security and billing control. As described earlier, the EVM 250 of a device provides a mechanism for a flexible and evolving central service to reprogram the local functions as needs evolve.

Now referring to FIG. 3, illustrated is a block diagram of a central device or facility. A system administration I/O interface 300 is provided in order for an administrator to update security information, receive device accounting reports, and perform other functions related to security and or billing to users and communications between users and devices. The system administration I/O interface 300 can include a simple workstation implementation which includes a display, a keyboard, external drives, and a printer. Information from the system administration I/O interface 300 is passed from a bus 310 to a processor 320. Processor 320 can include one or more processing devices or devices, with the primary function of processor 320 to manipulate and compute data. Processor 320 may be requested to fetch data from or to place data in a storage or memory device 330. The processor 320 further can instruct data to be placed in a network I/O interface 350 to be passed on to the communication network 150. A single bus 340 can be used for communication between the processor 320, the storage or memory device 330, and the network 350. Alternatively other communication busses can be used, along with other processing components in the central device.

Referring back to FIG. 1, the central device 100 can include one or more devices. If two or more central devices are used, a communication link is established between the devices in order to assure that there is no conflict, to update all central devices with current information, and to delegate tasks if the central devices are to take on independent functions.

The central device 100 can be a computer server or servers. Functions performed by the central device include validating users, assigning class of service, maintaining accounting databases, generating use pattern reports, maintaining libraries of device functions for detecting marks, measuring use, blocking functions, managing the assignment of specific security functions to the devices on the network as appropriate to users.

A possible embodiment of the central device 100 is an application program consisting of logic for security and billing policy running on a server(s), with administrator access via a web browser. This allows access from any network client with appropriate login rights. In addition to the logic, a central database on the same or a separate server contains the user identifications and permissions, device class capabilities, specific device configurations and permissions, libraries of document marks and other characteristics useful to the logic functions, and applets to be downloaded to specific devices in order to modify the functionality of each device.

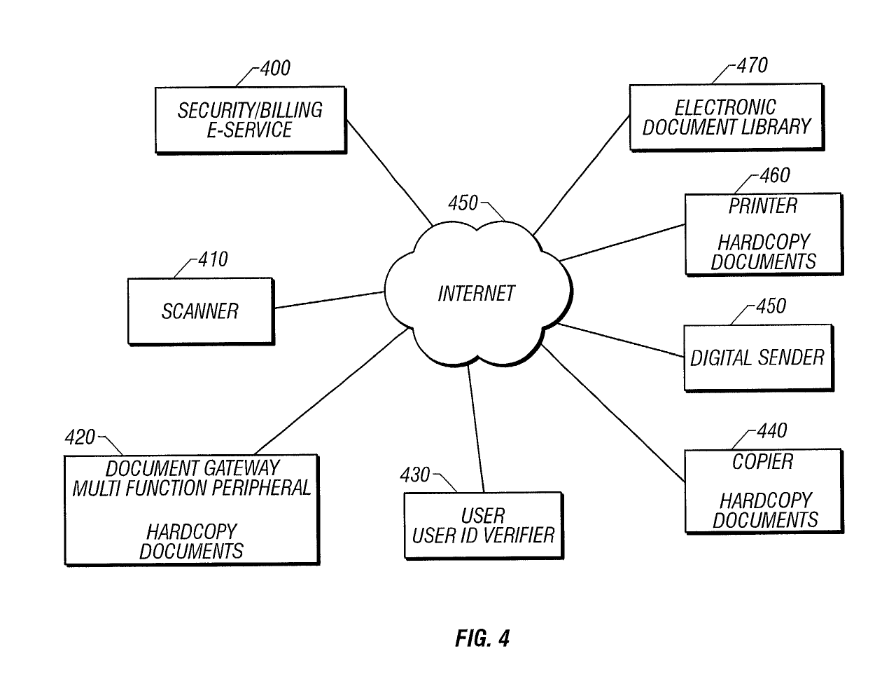

Now referring to FIG. 4 illustrated is an embodiment of a network architecture where the central device uses application program logic for security and billing policy which runs on a server device. A server can contain security or billing electronic service (e-service) logic 400, where the server is connected to the Internet 450. A user having a user identification (ID) verifier 430 is connected to the Internet 450, and through the Internet 450 accesses the security/billing e-service logic 400. The logic 400 uses the user/user ID verifier 430 to determine user access to other devices and to account for usage by the user of the devices. The user/user ID verifier 430 through the Internet 450 and “monitored/controlled” by the security/billing e-service logic 400 is able to access several devices. These devices can include devices in which documents or information are received from. In particular these devices can include a scanner 410, an electronic document library 470, and a digital sender 450. Devices that process or output documents include a printer 460 and a copier 440. Both the printer 460 and the copier 440 are readily capable of providing hard copy documents. An MFP 420 may act as a device that sends or processes the documents or information. Various embodiments can make use of different and numerous devices and a multitude of users.

Through the central device, in particular the logic 400, the user 430 can be provided information regarding status of a device, the user's access to particular devices, the operational status of the device, and account or billing status. A user may log into the central device or logic 400 through an embedded web server that is resident on the server containing the logic 400.

The user 430 may be queried to input a password and verify the password as illustrated in Table 1 below.

TABLE 1

| | |
|---|---|
| Enter Web Server Password: | XXXXXX |
| Repeat Password: | XXXXXX |

The central device or logic 400 then is able to provide to the user, a list of peripheral devices and their location (various addresses), as well as other identifiers that include the model number of the device. An exemplary device access table is shown in Table 2 below. The data in Table 2 provides the user 430 information regarding available devices. The PORT field relates to the port on the user computer. The IP ADDR field is the internet protocol address. IP HOSTNAME field is the internet protocol host. The “IPX NAME” field relates to the internetwork packet exchange (IPX) protocol that allows network drives to communicate with other workstations, servers, or devices on the internetwork (network).

TABLE 2

| RESOURCE | MODEL | H/W ADDR | PORT | IP ADDR | IP HOSTNAME | IPX NAME |
|---|---|---|---|---|---|---|
| Printer | LJ 4550 | 001898 | 1 | 15.64.66.109 | Npi56.boi.hp.com | NPI56C0F3 |
| Scanner | SC 5130 | 021598 | 1 | 15.55.77.110 | Jder1.pa.hp.com | NPI64C0F3 |
| Printer | IJ 5120 | 021780 | 2 | 15.54.75.110 | jt.ds.hp.com | NPI74C033 |
| Copier | CP 5120 | 013780 | 1 | 15.45.76.110 | Jps.jy.hp.com | NPI56C032 |

The user can also be given status related to an individual device. Table 3 illustrates an exemplary list of information regarding an individual device that can be made available to a user 430. Table 3 illustrates the status for a printer, however, the information can be adjusted to provide relevant information regarding other devices such as copiers, scanners, and MFPs.

TABLE 3

| Model | HP Color Laser Jet 4550 |
|---|---|
| IP Name | bou56c0f3.boi.hp.com |
| IP Address | 15.62.66.109 |
| IPX Address | NP156C0F3 |
| Hardware Address | 00108356C0F3 |
| Estimated Black Toner Level | 25% |
| Estimated Cyan Toner Level | 33% |
| Estimated Magenta Toner Level | 50% |
| Estimated Yellow Toner Level | 89% |
| Estimated Black OPC Level | 44% |
| Estimated Black Transfer Unit Level | 99% |
| Estimated Black Fuser Level | 98% |

Other information regarding status of the resource and supplies for the resource can also be provided to the user 430. Table 4 is an example of other information regarding a particular resource that can be provided. This information can be provided as the user 430 is using the device. Table 4 illustrates information that is relevant to a printer device. Information related to other peripheral devices can also be provided.

TABLE 4

| | |
|---|---|
| Operational Status | GO |

| | | |
|---|---|---|
| Paper Tray 1 | Letter Size | 54% |
| Paper Tray 2 | Legal Size | 79% |
| Paper Tray 3 | Letter | 56% |

Although the present invention has been described in connection with several embodiments, the invention is not intended to be limited to the specific forms set forth herein, but on the contrary, it is intended to cover such alternatives, modifications, and equivalents as can be reasonably included with in the spirit and scope of the invention as defined by the appended claims.

What is claimed is:

1. A method of allocating use of peripheral devices in a network system comprised of:
identifying users in the network system to a central device;
providing peripheral device access limitations to the users by the central device; and
informing the peripheral devices of the access allowed to users by the central device.

2. The method of claim 1 further comprising:
accounting peripheral device usage of the users by the central device.

3. The method of claim 1 wherein the peripheral devices perform document processing.

4. The method of claim 3 further comprising:
reading marks on documents processed by the peripheral devices; and
identifying by the marks the documents to the central device.

5. The method of clam 4 further comprising:
relating the identified documents to users that request the identified documents.

6. The method of claim 1 further comprising:
providing an embedded virtual machine in each of the peripheral devices wherein the embedded virtual machine interfaces to the central device.

7. The method of claim 6 wherein at least one of the peripheral devices is a multi-functional peripheral device whereby the central device configures the multi-functional peripheral device to serve specific functions.

8. The method of claim 1 wherein the central device comprises of logic in a server connected to the network system.

9. The method of claim 1 further comprising:
providing the users with collective and individual information and status of the peripheral devices.

10. A network system controlling and managing resource usage comprised of:
a central device;
one or more users; and
one or more peripheral devices, wherein the central device provides information to the peripheral devices as to access by the users.

11. The network system of claim 10 wherein the central device accounts for peripheral device usage of the users.

12. The network system of claim 10 wherein the peripheral devices process documents.

13. The network system of claim 12 wherein the documents are given a mark read by the peripheral devices and identified by the central device.

14. The network system of claim 13 wherein the documents are related to users that request the documents.

15. The network system of claim 10 wherein the peripheral devices are further comprised of an embedded virtual machine that interfaces to the central device.

16. The network system of claim 15 wherein at least one of the peripheral devices is a multi-functional peripheral device whereby the central device configures the multi functional peripheral device to serve specific functions.

17. The network system of claim 10 wherein the central device comprises control logic in a server connected to the network system.

18. The network system of claim 10 whereby users are provided collective and individual information and status of the peripheral devices.
